(19) United States
(12) Patent Application Publication
(10) Pub. No.: US 2025/0262546 A1
(43) Pub. Date: Aug. 21, 2025

(54) PROGRAM, INFORMATION PROCESSING APPARATUS, METHOD, AND SYSTEM

(71) Applicant: CYGAMES, INC., Tokyo (JP)

(72) Inventors: Yamato Taura, Tokyo (JP); Takahiro Shinkawa, Tokyo (JP); Makoto Noguchi, Tokyo (JP); Zhargal Naidanov, Tokyo (JP); Ryo Akiyama, Tokyo (JP); Yosuke Sato, Tokyo (JP); Isao Buchimaru, Tokyo (JP)

(73) Assignee: CYGAMES, INC., Tokyo (JP)

(21) Appl. No.: 19/202,461

(22) Filed: May 8, 2025

Related U.S. Application Data
(63) Continuation of application No. PCT/JP2023/040624, filed on Nov. 10, 2023.

(30) Foreign Application Priority Data
Nov. 10, 2022 (JP) 2022-180553

(51) Int. Cl. A63F 13/69; A63F 13/795

(52) U.S. Cl. CPC A63F 13/69; A63F 13/795

(57) ABSTRACT

An information processing apparatus includes: a party information association unit configured to execute: when an owned game medium owned by the player is included in the plurality of game media included in the party information of the other player, party information association processing of associating the owned game medium with party information of the player; and when an unowned game medium not owned by the player is included in the plurality of game media included in the party information of the other player, substitute determination processing of determining, from a plurality of the owned game media of the player, a substitute game medium substituting the unowned game medium, and party information association processing of associating the determined game medium with the party information of the player.

### TECHNICAL FIELD

The present invention relates to a program and the like, and in particular to a program and the like of a game including an operation of forming, by a player, a game medium group including a plurality of game media.

### BACKGROUND ART

In the related art, a game is known that is played using a game medium group including a plurality of game media. The game medium group used in such a game can be formed of game media owned by a player himself/herself.

### CITATION LIST

### Patent Literature

Patent Document 1: JP 5938451 B

### SUMMARY OF INVENTION

### Technical Problem

Such a game may have a party copy function of copying a game medium group of another player to a game medium group of a player. However, it is not always the case that the player owns all of the game media included in the game medium group of the other player to be copied, and the player cannot use the party copy function when not owning the game media included in the game medium group of the other player. Therefore, a player that wants to imitate the game medium group of the other player has no choice but to form a game medium group from the game media owned by the player himself/herself, and improvement in the user-friendliness of game medium group formation has been desired.

The present invention has been devised to solve such a problem, and an object thereof is to provide a program, an information processing apparatus, a method, and a system capable of improving player-friendliness of game medium group formation.

### Solution to Problem

A program according to an aspect of the present invention is a program for a game including an operation of forming, by a player, a game medium group including a plurality of game media, the program causing an information processing apparatus to function as:
a distinguishing unit configured to distinguish whether the player owns each of a plurality of game media included in party information related to a game medium group of another player; and
a party information association unit configured to execute:
when an owned game medium owned by the player is included in the plurality of game media included in the party information of the other player, party information association processing of associating the owned game medium with party information of the player; and
when an unowned game medium not owned by the player is included in the plurality of game media included in the party information of the other player, substitute determination processing of determining, from a plurality of the owned game media of the player, a substitute game medium substituting the unowned game medium, and party information association processing of associating the determined game medium with the party information of the player.

The program according to an aspect of the present invention may include at least one or more of the following configurations (2) to (7):
(2) in the substitute determination processing, the party information association unit determines, as the substitute game medium, the owned game medium that belongs to the player and that is associated with element information matching element information associated with a game medium included in the party information of the other player;
(3) when the unowned game medium is included in the plurality of game media included in the party information of the other player, the party information association unit executes, in accordance with selection by the player, the substitute determination processing or partial formation processing of associating only the owned game medium included in the party information of the other player with the party information of the player;
(4) in the substitute determination processing:
when a game medium associated with a rarity degree equal to or higher than a rarity degree of the unowned game medium is included in the plurality of owned game media of the player, the party information association unit determines the substitute game medium from the plurality of owned game media that belong to the player and that have a rarity degree equal to or higher than the rarity degree of the unowned game medium; and
when the game medium associated with the rarity degree equal to or higher than the rarity degree of the unowned game medium is not included in the plurality of owned game media of the player, the party information association unit determines the substitute game medium from game media having a highest rarity degree among game media having individual element information matching individual element information associated with the unowned game medium among the plurality of owned game media that belong to the player and that have a rarity degree lower than the rarity degree of the unowned game medium;
(5) at least one type of game medium is associated with a category corresponding to a first game medium and a category corresponding to a second game medium assisting the first game medium, the at least one type of game medium being associated with different element information for each category,
each of the plurality of game media included in the party information of the other player is associated with the category corresponding to the first game medium or the second game medium,
the information processing apparatus is further caused to function as a category identification unit configured to identify the category of the unowned game medium distinguished as not being owned by the player, and
in the substitute determination processing, the party information association unit determines, as the substitute game medium, a game medium among the plurality of owned game media of the player associated with the element information matching the element information for the identified category of the unowned game medium;
(6) the party information of the other player is party information related to a game medium group with which the other player has cleared a predetermined game; and
(7) in the configuration (6),
the predetermined game includes a multiplayer game.

An information processing apparatus according to an aspect of the present invention is an information processing apparatus for executing a game including an operation of forming, by a player, a game medium group including a plurality of game media, the information processing apparatus including:
a distinguishing unit configured to distinguish whether the player owns each of a plurality of game media included in party information related to a game medium group of another player, and
a party information association unit configured to execute:
when an owned game medium owned by the player is included in the plurality of game media included in the party information of the other player, party information association processing of associating the owned game medium with party information of the player; and
when an unowned game medium not owned by the player is included in the plurality of game media included in the party information of the other player, substitute determination processing of determining, from a plurality of the owned game media of the player, a substitute game medium substituting the unowned game medium, and party information association processing of associating the determined game medium with the party information of the player.

A method according to an aspect of the present invention is a method for a game executed by an information processing apparatus, the game including an operation of forming, by a player, a game medium group including a plurality of game media, the method including:
a distinguishing step of distinguishing whether the player owns each of a plurality of game media included in party information related to a game medium group of another player, and
a party information association step of executing:
when an owned game medium owned by the player is included in the plurality of game media included in the party information of the other player, party information association processing of associating the owned game medium with party information of the player; and
when an unowned game medium not owned by the player is included in the plurality of game media included in the party information of the other player, substitute determination processing of determining, from a plurality of the owned game media of the player, a substitute game medium substituting the unowned game medium, and party information association processing of associating the determined game medium with the party information of the player.

A system according to an aspect of the present invention is a system for a game including an operation of forming, by a player, a game medium group including a plurality of game media, the system including:
a plurality of information processing apparatuses, wherein
any of the plurality of information processing apparatuses functions as a distinguishing unit configured to distinguish whether the player owns each of a plurality of game media included in party information related to a game medium group of another player, and
any of the plurality of information processing apparatuses functions as a party information association unit configured to execute:
when an owned game medium owned by the player is included in the plurality of game media included in the party information of the other player, party information association processing of associating the owned game medium with party information of the player; and
when an unowned game medium not owned by the player is included in the plurality of game media included in the party information of the other player, substitute determination processing of determining, from a plurality of the owned game media of the player, a substitute game medium substituting the unowned game medium, and party information association processing of associating the determined game medium with the party information of the player.

### Advantageous Effects of Invention

According to the present invention, it is possible to improve a player's game experience.

### BRIEF DESCRIPTION OF DRAWINGS

FIG. 1 is a block diagram illustrating a hardware configuration of an information processing apparatus according to an embodiment of the present invention.

FIG. 2 is an example of a functional block diagram of the information processing apparatus according to the embodiment of the present invention.

FIG. 3 illustrates an example of a game screen according to the embodiment of the present invention.

FIG. 4 illustrates an example of the game screen according to the embodiment of the present invention and illustrates a skill in which a player character corresponding to a leading object stops for a predetermined time at a location in a game field at a time of skill activation and shoots a beam upward to damage an enemy object.

FIG. 5 is an example of a functional block diagram of a game control unit according to the embodiment of the present invention.

FIG. 6 illustrates an example of a party formation screen according to the embodiment of the present invention.

FIG. 7 illustrates an example of a game selection screen according to the embodiment of the present invention.

FIG. 8 illustrates an example of another player party selection reception screen according to the embodiment of the present invention.

FIG. 9 illustrates an example of a player party selection reception screen according to the embodiment of the present invention.

FIG. 10 illustrates an example of a confirmation screen according to the embodiment of the present invention.

FIG. 11 illustrates an example of a formation processing selection screen according to the embodiment of the present invention.

FIG. 12 illustrates an example of a copy notification screen according to the embodiment of the present invention.

FIG. 13 illustrates an example of a multiplayer game result screen according to the embodiment of the present invention.

FIG. 14 is an example of a flowchart of copy-related processing executed by the information processing apparatus according to the embodiment of the present invention.

FIG. 15 is an example of a flowchart of game processing executed by the information processing apparatus according to the embodiment of the present invention.

FIG. 16 is a diagram illustrating an example of an overall configuration of a game system according to the embodiment of the present invention.

### DESCRIPTION OF EMBODIMENTS

A game system according to an embodiment of the present invention will be described with reference to the drawings. In the present specification, for convenience of description, a detailed description more than necessary may be omitted. For example, a detailed description of an already well-known matter and a redundant description of substantially the same configuration may be omitted.

This game system can be achieved by a system in which a plurality of information processing apparatuses are connected via a network, but can also be achieved by a single information processing apparatus. First, an embodiment achieved by one information processing apparatus will be described, and then a system connected to a network will be described.

### Embodiment Achieved by Information Processing Apparatus

### Schematic Configuration

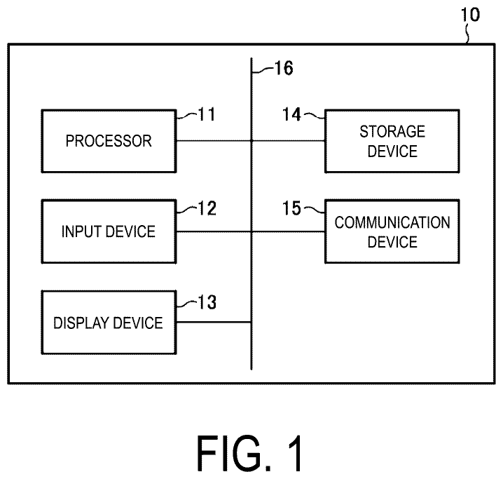

FIG. 1 is a block diagram illustrating a hardware configuration of an information processing apparatus 10 according to an embodiment of the present invention. The information processing apparatus 10 includes a processor 11, an input device 12, a display device 13, a storage device 14, and a communication device 15. Each of the components 11 to 15 is connected via a bus 16. Note that an interface may be interposed between the bus 16 and each of the components 11 to 15 as necessary. In the present embodiment, the information processing apparatus 10 is a smartphone. However, the information processing apparatus 10 can be a terminal such as a tablet computer or a computer including a contact-type input device such as a touch pad as long as the information processing apparatus 10 has the above-described configuration.

The processor 11 controls the overall operation of the information processing apparatus 10 and is an electronic circuit such as a CPU or an M PU. The processor 11 executes various types of processing by reading and executing programs and data stored in the storage device 14. In one example, the processor 11 includes a plurality of processors.

The input device 12 is a user interface that receives an input from a user to the information processing apparatus 10, and is, for example, a touch panel, a touch pad, a keyboard, or a mouse. Since the information processing apparatus 10 of the present embodiment is a smartphone, the information processing apparatus 10 includes a touch panel. This touch panel functions as both the display device 13 and the input device 12. The display device 13 and the input device 12 may be separately disposed at different locations.

The display device 13 displays an application screen or the like for the user of the information processing apparatus 10, that is, a player, under control of the processor 11. As the display device 13, a liquid crystal display, an organic EL display, a plasma display, or the like can be used.

The storage device 14 includes a main memory, a buffer memory, and a storage, and is a storage device included in a typical smartphone or computer, such as a storage device using a RAM, which is a volatile memory, and a flash memory such as an eMMC, a UFS, or an SSD, which is a non-volatile memory, and a magnetic storage device. The storage device 14 can include an external memory. The storage device 14 stores, for example, a game application. The game application includes a game program for executing a game, and various types of data and various tables referred to when the game program is executed. The game program is started in response to an operation by the user on the information processing apparatus 10, and executed on an operating system (OS) installed in advance in the information processing apparatus 10.

In one example, the storage device 14 includes a main storage device and an auxiliary storage device. The main storage device is a volatile storage medium capable of high-speed reading and writing of information, and is used as a storage area and a work area when the processor 11 processes information. The auxiliary storage device stores various programs and data used by the programs when the programs are executed. The auxiliary storage device is, for example, an SSD or a hard disk device, but may be any non-volatile storage or non-volatile memory as long as information can be stored therein, and may be a detachable device. The auxiliary storage device stores, for example, an operating system (OS), middleware, an application program, and various types of data that can be referred to along with execution of these programs.

The communication device 15 transmits and receives data to and from another computer such as a server via a network. For example, the communication device 15 performs wireless communication such as mobile communication or wireless LAN and is connected to the network. In one example, in the information processing apparatus 10, a program is downloaded by the communication device 15 from the server and stored in the storage device 14. However, the communication device 15 may perform wired communication using an Ethernet (trade name) cable or the like. When data is not transmitted to or received from another computer, the information processing apparatus 10 does not need to include the communication device 15.

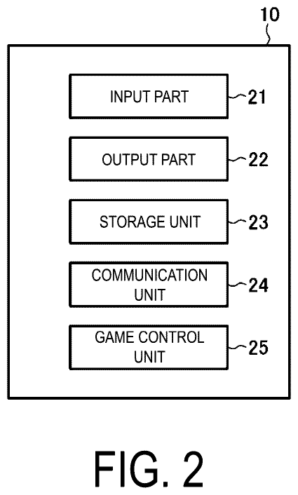

FIG. 2 is an example of a functional block diagram of the information processing apparatus 10 according to the embodiment of the present invention. The information processing apparatus 10 includes an input part 21, an output part 22, a storage unit 23, a communication unit 24, and a game control unit 25. In the present embodiment, these functions are implemented by the processor 11 executing a program. For example, the executed program is a game program stored in the storage device 14 or received via the communication device 15. In this way, since various functions are implemented by reading the program, one part (function) may be partially or wholly included in another part. The various functions are implemented as respective units by executing the program. By configuring an electronic circuit or the like for partially or wholly implementing each function, these functions may be implemented by hardware.

The input part 21 is configured using the input device 12 and receives an input from the user to the information processing apparatus 10. The input part 21 can have a touch detection function that a smartphone equipped with a touch panel typically has. The output part 22 uses the display device 13, a sound output device such as a speaker, or the like, and outputs information related to a game, the progress of the game, a game screen according to a user operation, and the like, to the information processing apparatus 10 in order to present the information to the user. The storage unit 23 is configured using the storage device 14, and stores information and programs related to various games. The communication unit 24 is configured using the communication device 15, and functions as an interface that transmits and receives information to and from an external device such as another information processing apparatus 10. The communication unit 24 may transmit input information from the user received by the input part 21 to the external device such as the other information processing apparatus 10 via the network. Further, the communication unit 24 may receive information from the external device such as the other information processing apparatus 10 and send the information to each unit.

The game control unit 25 performs basic control when executing a game of the present embodiment. The game control unit 25 includes the processor 11, executes the game, and causes the display device 13 to display a screen related to the game. The execution of the game by the game control unit 25 can include acquiring information necessary for the execution from the storage device 14, acquiring operation information on the player via the input device 12, the communication device 15, and/or the network, performing information processing of the game based on the necessary information, and generating and/or acquiring, based on the information processing, information necessary for displaying a screen to be displayed on the display device 13.

### Detailed Configuration

Next, the game and the game control unit 25 of the present embodiment will be described in detail. The game of the present embodiment includes an operation of forming, by the player, a game medium group including a plurality of game media. That is, the game is only required to be executed using a game medium group formed based on an operation by the player or another player, and may be an action game that progresses in real time, such as a match game. The game of the present embodiment is a pinball game. The game of the present embodiment may be a multiplayer game. The pinball game may be a multiplayer pinball game played by a plurality of players.

The game medium group includes a plurality of game media, and can be referred to as a party, a group, a unit, a set, or a team. Each game medium is electronic data used in the game, such as a character, a weapon, equipment, an equipment item, an ability item, and an item such as a card. Each game medium is associated with a unique game medium ID.

In the present embodiment, a plurality of characters, equipment items, and ability items are set in advance as game media by a game administrator or the like.

Each character is associated with an individual parameter and a skill. Examples of the individual parameter include a level, attack power, defense power, hit points (HP), special ability (ability), and rarity degree. The special ability (ability) is an ability that can be activated when a predetermined condition is satisfied. Examples of the special ability include an ability to increase attack power by a predetermined number or recover HP by a predetermined number every time a predetermined number of enemy characters are defeated, and an ability to increase attack power by a predetermined number or increase damage caused by a skill to an enemy character by a predetermined percentage when the game or battle starts. In this way, the ability is associated with an activation condition and an effect amount (parameter change amount) at a time of the activation. The skill is a character-unique skill activated by an input from the player via the input device 12, and is associated with an effect of a parameter change amount of a predetermined character, a damage amount to an enemy character by the skill, or the like.

Each equipment item is associated with an individual parameter such as attack power, HP, and rarity degree, and a parameter change amount. The parameter change amount is a change amount of an individual parameter of a character and/or a change amount of an individual parameter of a predetermined character of a game medium group including the character when the equipment item is associated with the character (that is, when the character is equipped with the equipment item). In one example, the parameter change amount can be set such that a predetermined parameter (for example, attack power) of the character associated with the equipment item is increased by a predetermined percentage (for example, 30%). The parameter change amount may be increased by satisfying a predetermined condition. In one example, the parameter change amount can be set such that when the character associated with the equipment item has a predetermined attribute, a predetermined parameter (for example, attack power) of the character is increased by a predetermined percentage (for example, 30%).

Each ability item is associated with a parameter change amount and a rarity degree. The parameter change amount is a change amount of an individual parameter of a character and/or a change amount of an individual parameter of a predetermined character of a game medium group including the character when an ability item is associated with the character (that is, when the character is equipped with the ability item). In one example, the parameter change amount can be set such that a predetermined parameter (for example, attack power) of the character associated with the ability item is increased by a predetermined percentage (for example, 30%). The parameter change amount may be increased by satisfying a predetermined condition. In one example, the parameter change amount can be set such that when the character associated with the ability item has a predetermined attribute, a predetermined parameter (for example, attack power) of the character is increased by a predetermined percentage (for example, 30%). The parameter change amount of the ability item can be set to be different from the parameter change amount of the equipment item. In one example, the parameter change amount of the ability item can be less than the parameter change amount of the equipment item.

In the present embodiment, each game medium is associated with element information. The element information can be information indicating a feature and/or a characteristic of the game medium. The element information can include a plurality of pieces of priority element information associated with priorities. The priority element information of each priority can include one or more pieces of individual element information. Therefore, the element information can include a plurality of pieces of individual element information. In other words, the game medium is associated with a plurality of pieces of individual element information associated with priorities. The individual element information is the type of a feature and/or a characteristic of the game medium in the priority of the priority element information.

Specifically, the priority of the priority element information can have a plurality of levels (for example, five levels). In one example, the priority element information has the highest priority when the priority is 5 and has the lowest priority when the priority is 1. The priority element information can be set by extracting and/or breaking down the game element of the game medium such that the feature and/or the characteristic of the game medium becomes more conspicuous as the priority becomes higher. For example, priority element information having a priority of 5 is a special skill associated with only a specific game medium, priority element information having a priority of 4 is a strategy and a tactic concept of the game medium on the game, and priority element information having a priority of 3 is a role in a party. Priority element information having a priority of 2 is a rarity degree of the game medium, and priority element information having a priority of 1 is an ability having a maximum parameter increase range in the game medium. In this case, individual element information having a priority of 5 is the type of a special skill, individual element information having a priority of 4 is the type of a strategy or a tactic concept on the game (for example, skill, direct attack, or ability), individual element information having a priority of 3 is the type of a role in a party (for example, attack or recovery), individual element information having a priority of 2 is the type of a rarity degree (for example, from single star to five star), and individual element information having a priority of 1 is the type of an ability.

Each of the character, the equipment item, and the ability item is one type of game medium. At least one type of game medium is associated with a category corresponding to a first game medium and a category corresponding to a second game medium that assists the first game medium. In the present embodiment, the character is associated with the category corresponding to the first game medium and the category corresponding to the second game medium. Here, the first game medium is a first player character, and the second game medium is a second player character associated with the first player character. In one example, the first player character is a main character displayed as a player object in a below-described game field, and the second player character is an assist character not displayed as a player object in the game field. The player selects game media (characters) when forming a game medium group, and thus the first and second player characters can be set by the game control unit 25.

In other words, game medium groups constituting parties of the player and other players can include a first player character, a second player character, an equipment item, and an ability item. Note that the category may be associated with an equipment item and/or an ability item.

In addition to the game medium being associated with the category corresponding to the first game medium (first category) and the category corresponding to the second game medium (second category), the game medium is associated with element information different for each category. In one example, when a certain game medium is in the category corresponding to the first game medium, the certain game medium is associated with a plurality of pieces of individual element information. On the other hand, when the certain game medium is in the category corresponding to the second game medium, the certain game medium is associated with a plurality of pieces of individual element information different from those when the certain game medium is in the category corresponding to the first game medium. Therefore, even the same game medium can have a different result of substitute processing determination described below depending on the category. In this way, the game medium is associated with the element information in the first category and the element information in the second category. Note that at least one game medium may be associated with the element information in the first category and the element information in the second category that are common or the same.

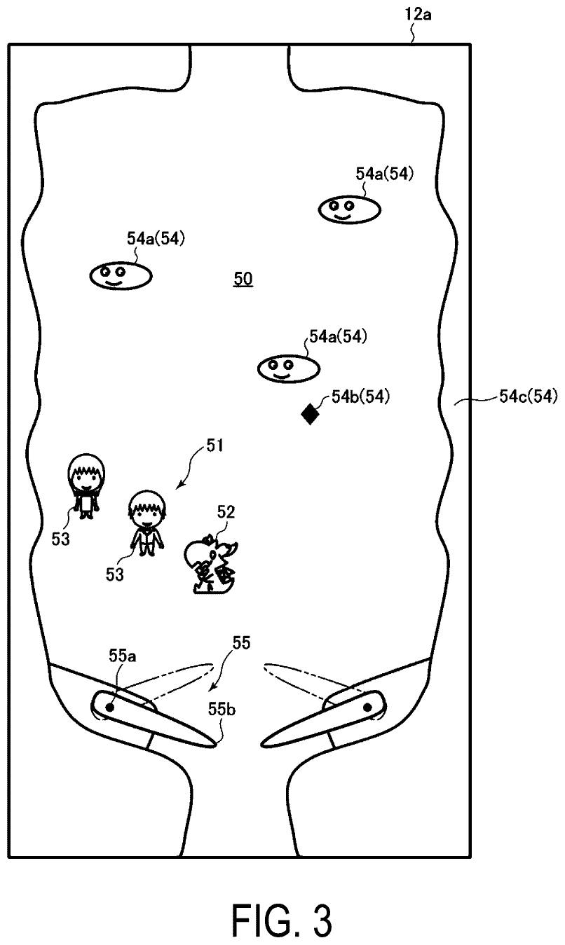

As described above, the game of the present embodiment is a pinball game and includes a plurality of game fields 50 corresponding to a plurality of game stages. The game fields 50 are generated or set by the game control unit 25 as virtual spaces for the progress of the game and displayed on the display device 13. The game control unit 25 can dispose objects in a different manner for each game field 50. FIG. 3 illustrates an example of one game field 50.

FIG. 3 is a diagram illustrating an example of the game screen. The game screen illustrated in FIG. 3 is a screen displayed on the entire screen or most of the screen of a touch panel 12a of the information processing apparatus 10 functioning as the display device 13. On the touch panel 12a, a location is identified by coordinates using a coordinate plane having a vertical-axis direction and a horizontal-axis direction. The game control unit 25 identifies a location in the game field 50 using the coordinates. The game control unit 25 sets the lengths of the game screen in the vertical-axis direction and the horizontal-axis direction to predetermined lengths, for example, 1920 pixels and 1080 pixels, and uses pixel values when identifying a distance or location in the game field 50 regardless of the size or the image resolution of the touch panel 12a. Note that the identification of a location in the game field 50 is not limited to the above, and the game control unit 25 can use a known method capable of identifying a location in the game field 50 displayed in a size corresponding to the size of a game screen on each of touch panels 12a having different sizes or screen resolutions.

The game control unit 25 generates a game field 50 being a virtual space surrounded by a virtual wall 54c, and disposes various objects in accordance with the progress of the game. In the game field 50 illustrated in FIG. 3, a party object 51, collision objects 54, and an operation object 55 are disposed.

The party object 51 includes a leading object 52 that moves in the game field 50 and a following object 53 that follows the leading object 52. In one example, as illustrated in FIG. 3, the party object 51 includes one leading object 52 that moves at the leading position, one following object 53 that follows the leading object 52 at the second position, and a following object 53 that follows the second following object 53 at the third position.

Each of the objects 52 and 53 constituting the party object 51 is a player object corresponding to a player character that is a game medium included in a game medium group used in the game, or an object. The player object is a subject that can be directly or indirectly operated by the user. The number of player objects constituting the party object 51 may be one or more, and is not particularly limited. For example, the leading object 52 alone may constitute the party object 51, and the number of following objects 53 may be one, two, three or more.

Note that since the player object and the player character are associated with each other, an individual parameter and a skill are only required to be associated with at least one of the player object or the player character. That is, the game control unit 25 may set the individual parameter and the skill for the player character associated with the player object, or may set the individual parameter and the skill for the player object associated with the player character. In one example, the game control unit 25 can associate the player object, the player character, the individual parameter, and the skill with each other using a uniquely assigned ID. A method of setting such an individual parameter and skill is the same for other objects. Unless otherwise specified, the individual parameter is simply referred to as a parameter.

Each collision object 54 is an object with which the player objects constituting the party object 51 can collide. Examples of the collision object 54 include an enemy object 54a, an attack object 54b, and an installation object.

The enemy object 54a and the attack object 54b are objects that attack the player objects and damage the player objects. The enemy object 54a corresponds to an enemy character. The attack object 54b corresponds to a flying object such as a bullet, a beam, an arrow or the like shot from the enemy object 54a in a predetermined direction.

The installation object is an object disposed in the game field 50, the player objects collide with the installation object, and the movement of the player objects in the game field 50 is affected. The installation object can include the wall 54c constituting the game field 50, and a block (not illustrated), an obstacle (not illustrated), and the like disposed in the game field 50. The installation object may be fixedly disposed at a predetermined location in the game field 50, or may move in the game field 50.

The game control unit 25 sets a virtual gravity in the game field 50. The virtual gravity is a gravity obtained by reproducing, in the virtual space, a phenomenon similar to the gravity in the real world. The game control unit 25 performs physics calculation using dynamic parameters including the virtual gravity and a coefficient of restitution. A known physics engine can be used for the physics calculation. The game control unit 25 sets dynamic parameters such as a mass, shape, location, speed, and coefficient of restitution for each of the player objects, the collision objects 54, and the operation object 55. These dynamic parameters are parameters for the physics calculation different from individual parameters and the like corresponding to the player character. The dynamic parameters such as a mass, shape, and coefficient of restitution are set in advance by the game administrator or the like.

The leading object 52 is an object moving at the leading position of the party object 51, and is an object corresponding to a ball of a pinball game. Therefore, the leading object 52 is an object that can move in a manner similar to the ball. The game control unit 25 controls an operation so that the leading object 52 moves in the game field 50 in accordance with the virtual gravity, and the leading object 52 is accelerated in a gravity direction under the influence of the virtual gravity. In the game field 50 illustrated in FIG. 3, the gravity direction is a downward direction.

The game control unit 25 controls an operation so that the following objects 53 move to follow the trajectory of the leading object 52 in the game field 50. Therefore, the party object 51 moves in a line as a whole. Preferably, the game control unit 25 performs control so that the following objects 53 move to follow the leading object 52 while keeping a constant distance from the leading object 52. Preferably, the game control unit 25 also performs control so that the following objects 53 follow the leading object 52 while keeping a constant distance between the following objects 53.

The game control unit 25 determines a collision of the leading object 52 of the party object 51 with the collision objects 54 including the enemy object 54a and the attack object 54b, and the operation object 55. A known method can be used for the collision determination (hit determination).

When it is determined that the leading object 52 and the enemy object 54a have collided with each other, the game control unit 25 calculates a physical quantity acting on the leading object 52 at a time of the collision by using the dynamic parameters of the respective objects. The game control unit 25 determines the speed of the leading object 52 using the physical quantity of the calculation result, and moves the leading object 52. In this way, the game control unit 25 performs physics calculation related to a bouncing motion of the leading object 52 at a time of the collision. The same applies to a case where the leading object 52 collides with the operation object 55 or the installation object such as the virtual wall 54c.

When it is determined that the leading object 52 and the enemy object 54a have collided with each other, the game control unit 25 changes, based on an individual parameter set for the leading object 52, an individual parameter set for the enemy object 54a determined to have collided.

In one example, when it is determined that the leading object 52 and the enemy object 54a have collided with each other, the game control unit 25 determines that the player character associated with the leading object 52 has damaged the enemy character associated with the enemy object 54a. At this time, the game control unit 25 calculates the amount of damage from the individual parameter such as attack power set for the player character associated with the leading object 52. Subsequently, the game control unit 25 changes, using the calculated amount of damage, the individual parameter of the enemy character associated with the enemy object 54a determined to have collided, such as decreasing the HP of the enemy character.

The collision objects 54 including the enemy object 54a are set as objects not affected by the virtual gravity, and thus the game control unit 25 can continuously dispose the enemy object 54a at a location where a game property thereof is improved. In one example, the enemy object 54a (enemy character) shoots the attack object 54b, and when any player object of the party object 51 collides with the attack object 54b, the game control unit 25 determines that the colliding player object has received damage. At this time, the game control unit 25 changes the parameter of the player character associated with the player object, such as decreasing the HP of the player character. However, the collision objects 54 can be objects not affected by the virtual gravity.

The operation object 55 is an object operated by the user, and is a ball hitting object corresponding to a flipper in a pinball game. As illustrated in FIG. 3, the operation object 55 is a pair of ball hitting objects. Each of the pair of ball hitting objects rotates by a predetermined angle or a predetermined distance around one end portion 55a on the outside so that another end portion 55b is displaced up and down.

In one example, when it is determined that the leading object 52 and the operation object 55 have collided with each other, the game control unit 25 performs physics calculation related to a bouncing motion at a time of the collision, and determines the speed of the leading object 52 using the result of the physics calculation. Preferably, the game control unit 25 corrects a force to be applied from the operation object 55 to the leading object 52 and an angle in consideration of the operability for the user. Note that the operation object 55 may be one ball hitting object or three or more ball hitting objects.

The game control unit 25 operates the operation object 55 based on the user's touch detected by the touch panel 12a of the information processing apparatus 10. Specifically, when the touch panel 12a receives a touch, the game control unit 25 displaces the another end portion 55b of each ball hitting object to a predetermined location upper than when the touch panel 12a does not detect the touch. While the touch panel 12a is receiving the touch, the game control unit 25 holds the another end portion 55b of the ball hitting object at the predetermined location. In one example, the game control unit 25 can receive a touch at every location that can be detected by the touch panel 12a and execute the same processing. The operation object 55 collides with the player objects in a manner similar to the collision objects 54, but is different from the collision objects 54 in that the operation object 55 operates in response to an input from the user.

In the game of the present embodiment, the player can exercise a special effect by activating a skill. It is assumed that a skill is associated with each player character, and every player character has only one skill. Examples of the skill include a skill for greatly damaging an enemy character and a skill for exercising an effect such as recovering the HP of the player character. For example, when a skill gauge increased at a predetermined speed is increased to the maximum, the skill can be activated by consuming all the skill gauge.

In one example, the skill can be activated by a swipe input. The swipe input is operation input in which the player's finger or the like is brought into contact with the touch panel 12a of the information processing apparatus 10, moved with the contact maintained, and then separated from the touch panel 12a. The swipe input includes a slide operation and a flick operation. In one example, a swipe direction in which the skill is activated can be set to a direction different for each of the player characters corresponding to the player objects constituting the party object 51. On condition that the skill gauge is at a maximum, for example, the skill of the leading object 52 can be activated by performing a swipe input in the left direction, the skill of the second following object 53 following the leading object can be activated by performing a swipe input in the upward direction, and the skill of the third following object 53 can be activated by performing a swipe input in the right direction. The game control unit 25 of the present embodiment activates the skill of each player object by executing skill processing associated with the player object based on a player input such as a swipe input.

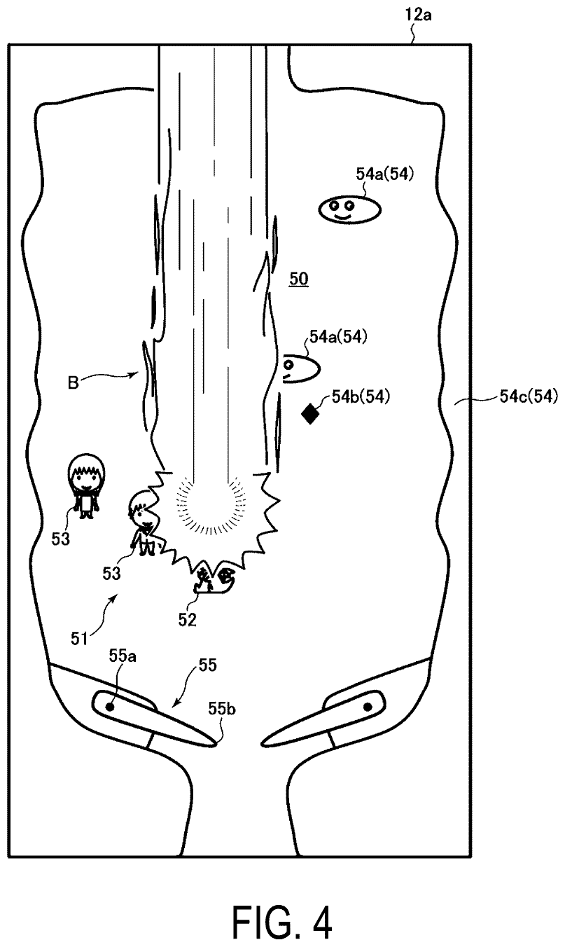

Various skills are set in advance in accordance with player characters. Examples of the skill include a skill of stopping the player character at a location in the game field 50 at a time of skill activation for a predetermined time and shooting a beam upward to damage the enemy object 54a, a skill of moving the player character in a predetermined direction (for example, right direction) for a predetermined time or by a predetermined number of pixels to damage the colliding enemy object 54a, a skill of moving the player character according to the virtual gravity to damage the enemy object 54a located within the range of an attack aura surrounding the player character, and a skill of shooting an arrow to damage the hit enemy object 54a and also restoring a predetermined number of the HP of all player characters corresponding to the player objects constituting the party object 51 each time an arrow is shot. FIG. 4 illustrates a skill in which the player character corresponding to the leading object 52 stops for a predetermined time at a location in the game field 50 at a time of skill activation and shoots a beam B upward to damage the enemy object 54a.

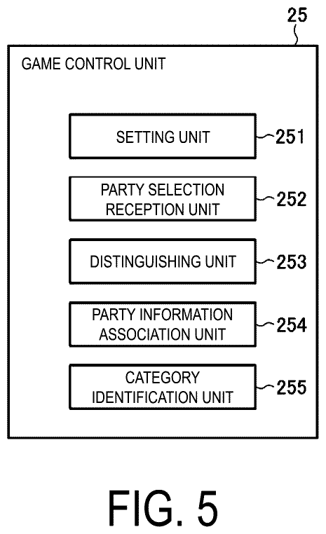

FIG. 5 illustrates examples of functional blocks of the game control unit. The game control unit 25 includes a setting unit 251, a party selection reception unit 252, a distinguishing unit 253, a party information association unit 254, and a category identification unit 255.

The setting unit 251 sets party information that belongs to the player and that is related to a game medium group including a plurality of game media selected by the player from a plurality of game media of the player. Specifically, the setting unit 251 receives selection of game media by the player via the input device 12 from a plurality of game media associated with the player, and stores, in the storage device 14, the game medium ID of each selected game medium and party information ID of the player in association with each other. The party information includes the IDs of the game media constituting the game medium group and is associated with the player ID and the party information ID.

The setting unit 251 of the present embodiment receives selection by the player of a first player character, a second player character, an equipment item, and an ability item, and configures the game medium group (party) with these game media. The setting unit 251 sets the association of these game media. In one example, the setting unit 251 sets the association by storing the IDs associated with the first player character and the second player character selected by the player in the storage device 14 in association with each other.

The first player character and the second player character may have an equal relationship, but the setting unit 251 of the present embodiment sets a master-slave relationship. That is, the first player character is set as a main character and the second player character is set as an assist character that assists the first player character. The first player character is selected and thus the main character is determined, and the second player character is selected and thus the assist character that assists the main character is determined. In a manner similar to the above, the order of selection may be reversed. The assist character may be determined first and then the main character may be determined.

When the first player character and the second player character have a master-slave relationship, the assist character can be regarded as an equipment item of the main character and assist the main character. Since the main character is equipped with the assist character (the assist character acts in unison), the assist character is also referred to as a unison character. As an assist mode, for example, the assist character itself has attack power, HP, skill, and ability, and thus the attack power, HP, skill, and ability of the assist character can be added to the attack power, HP, skill, and ability including at least the skill of the main character.

In the present embodiment, by setting a master-slave relationship, the game control unit 25 displays a player object corresponding to the main character in the game field 50, and does not display an assist object corresponding to the assist character. That is, the assist object is a hidden subject. However, the assist object may also be displayed in the game field 50, or when the first player object and the second player object do not have a master-slave relationship but have an equal relationship, both objects may be displayed. Note that each of the leading object 52 and the following objects 53 is a player object corresponding to the main character and is not the assist object.

The setting unit 251 can set the association between the first player character and the second player character for each of the plurality of player objects. In the example illustrated in FIG. 3, since three player objects constitute the party object 51, the association between a main character corresponding to the leading object 52 and an assist character that assists the main character, the association between a main character corresponding to the second following object 53 and an assist character that assists the main character, and the association between a main character corresponding to the third following object 53 and an assist character that assists the main character are set. Therefore, in this case, six characters are selected from a common character group.

The setting unit 251 can set an equipment item and an ability item selected by the player in association with the first player character and/or the second player character. In one example, the setting unit 251 can set the association by storing the ID of each of the equipment item and the ability item selected by the player in the storage device 14 in association with the first player character ID and/or the second player character ID. In this way, by associating the equipment item and the ability item with the player character, it is possible to identify the character that obtains effect amounts of the equipment item and the ability item.

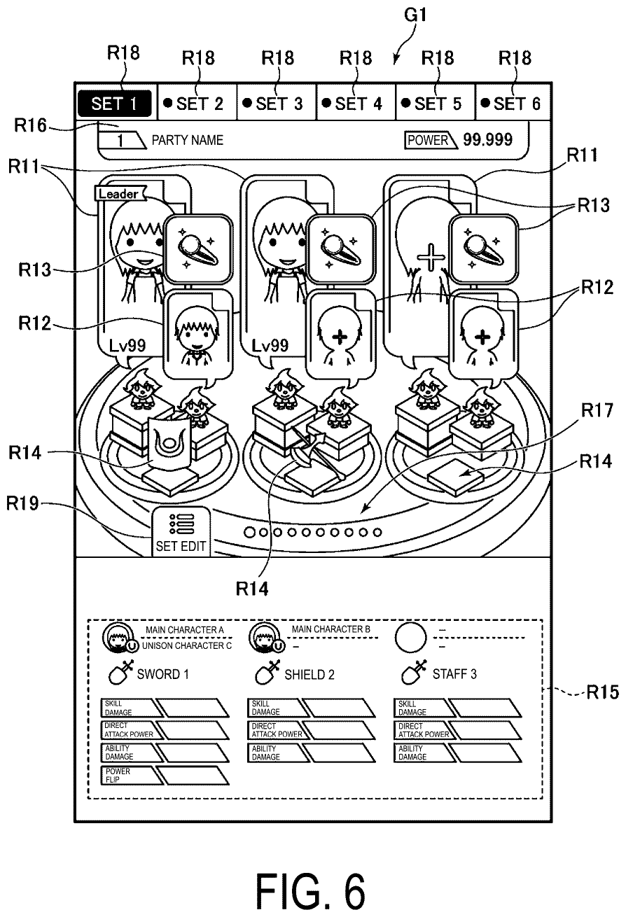

The setting unit 251 can cause the display device 13 to display a party formation screen G1 (for example, see FIG. 6 described below) for the above-described various settings, and can receive selection by the player of a player character, an equipment item, an ability item, and the like via the input device 12. The associations between the first player character, the second player character, the equipment item, and the ability item are associated with areas R11 to 14 of the party formation screen G1.

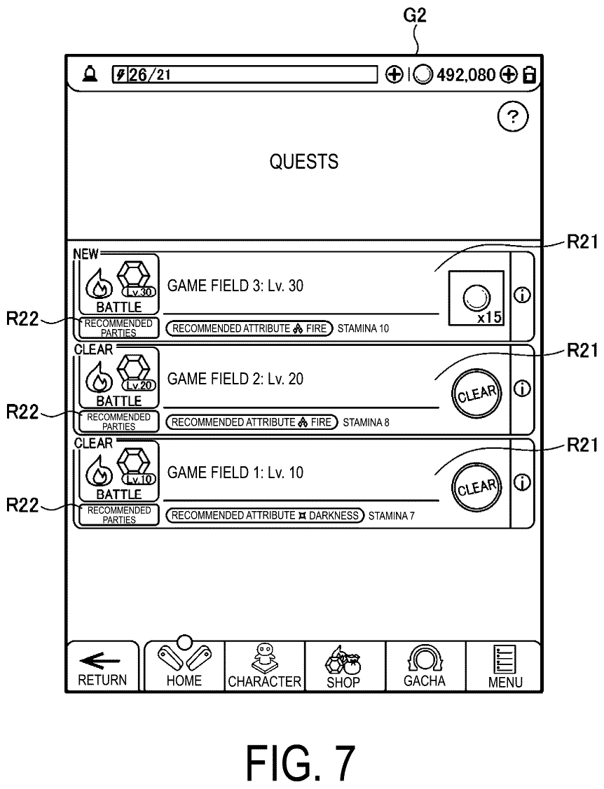

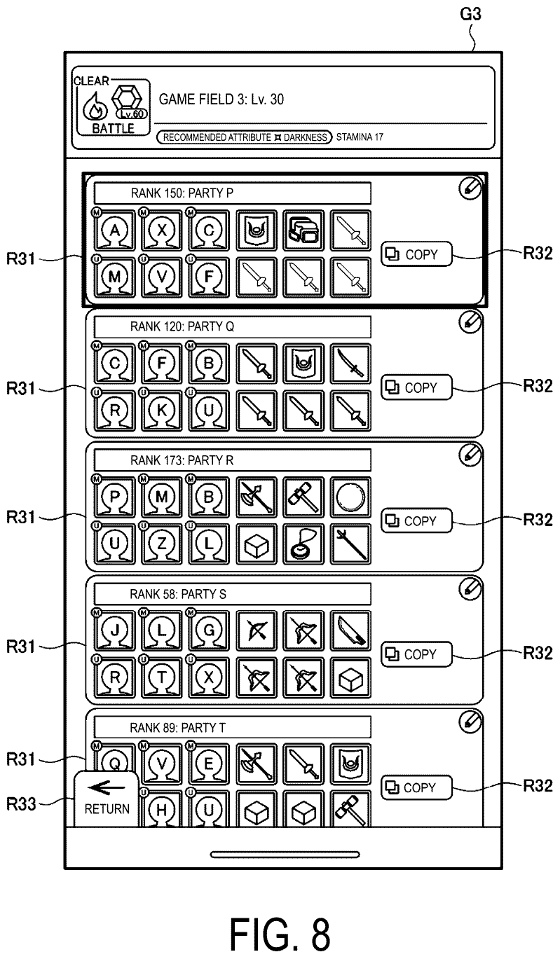

The party selection reception unit 252 receives selection by the player of a game medium group of another player from a plurality of game medium groups of other players. Specifically, the party selection reception unit 252 causes the display device 13 to display another player party selection reception screen G3 (for example, see FIG. 8 described below) including a plurality of game medium groups of other players, and receives selection by the player of a game medium group of another player via the input device 12. The selected game medium group is a game medium group serving as a copy source. The game medium groups displayed on the another player party selection reception screen can be game medium groups of other players who have cleared a predetermined game such as a quest. In this case, the party selection reception unit 252 can cause the display device 13 to display a game selection screen G2 (for example, see FIG. 7 described below) that allows selection from a plurality of predetermined games and that includes below-described recommended parties buttons (R22 in FIG. 7) associated with the predetermined games. The party selection reception unit 252 can cause the display device 13 to display the another player party selection reception screen G3 in response to selection by the player from the recommended parties buttons R22. Note that the predetermined game may be a multiplayer game.

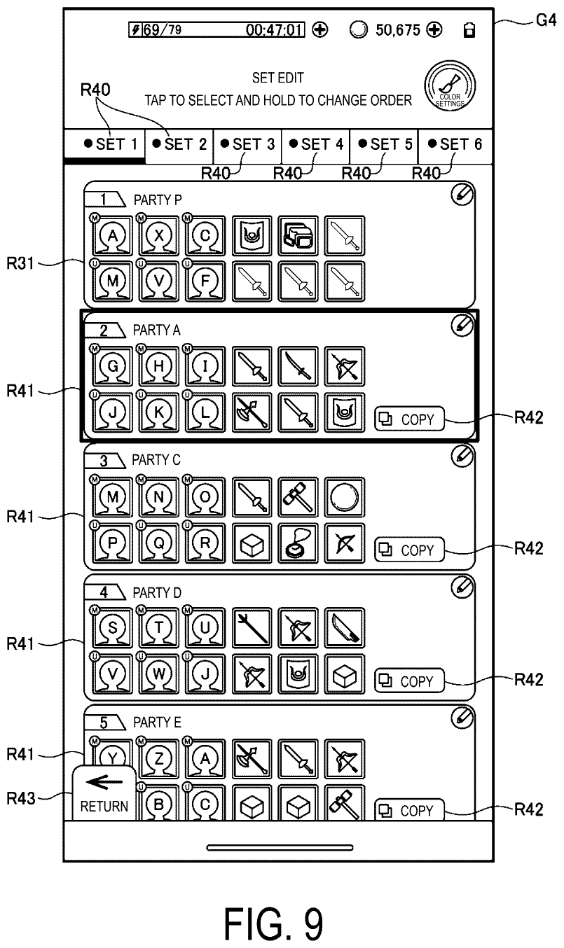

The party selection reception unit 252 receives selection by the player of a game medium group associated with the player. Specifically, the party selection reception unit 252 causes the display device 13 to display a player party selection reception screen G4 (for example, see FIG. 9 described below) including a plurality of game medium groups of the player, and receives selection by the player of a game medium group of the player via the input device 12. The selected game medium group of the player is a game medium group serving as a copy destination, and is a subject to be overwritten or replaced with the game medium group that belongs to the other player and that is selected on the another player party selection reception screen G3. The party selection reception unit 252 can display, on the player party selection reception screen G4 (see FIG. 9), the game medium group that belongs to the other player and that is selected on the another player party selection reception screen G3.

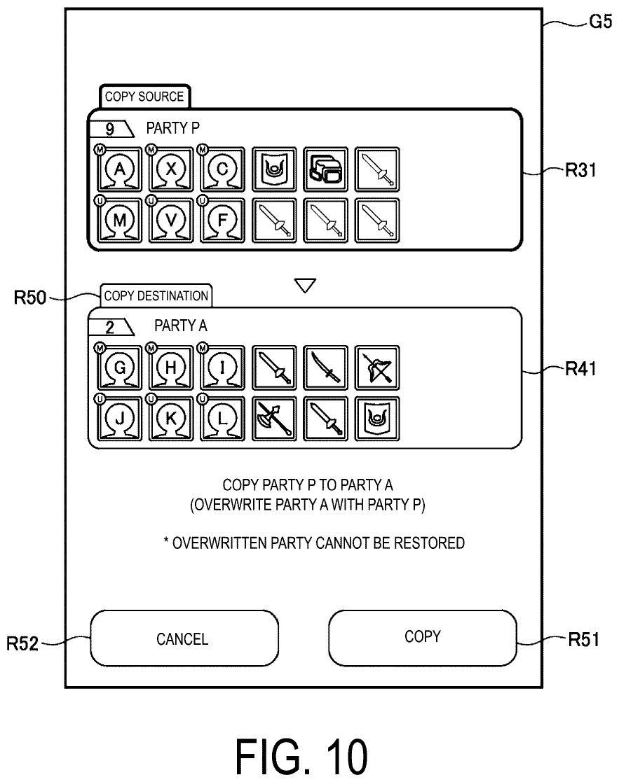

The party selection reception unit 252 causes the display device 13 to display a confirmation screen G5 (for example, see FIG. 10 described below) for confirming whether to copy the game medium group that belongs to the other player and that is selected by the player to the game medium group that belongs to the player and that is selected by the player, and receives selection by the player of whether the copy is necessary. Here, the copy refers to overwriting or replacing the game medium group that belongs to the player and that is selected by the player with the game medium group that belongs to the other player and that is selected by the player. M ore specifically, the copy refers to overwriting or replacing the game medium IDs included in the party information of the game medium group that belongs to the player and that is selected by the player with the game medium IDs included in the party information of the game medium group that belongs to the other player and that is selected by the player, associating the game medium IDs with the party information ID that belongs to the player and that serves as the copy destination, and storing the game medium IDs in the storage device 14.

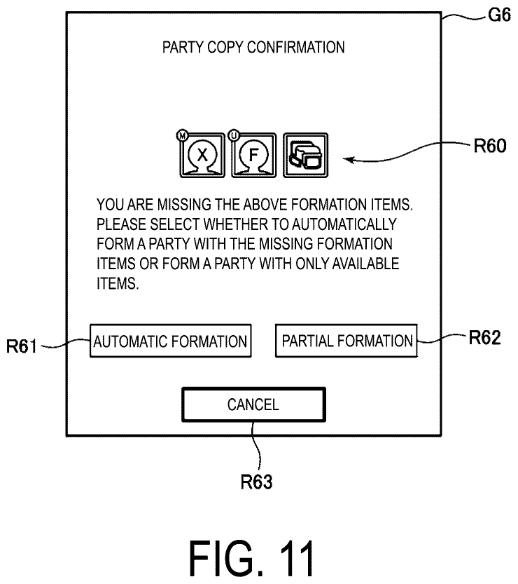

When the player does not own a game medium included in the game medium group that belongs to the other player and that is selected by the player, the party selection reception unit 252 can cause the display device 13 to display a formation processing selection screen G6 (for example, see FIG. 11 described below). The party selection reception unit 252 receives selection of formation processing via the formation processing selection screen G6 and the input device 12. The formation processing can include automatic formation processing and partial formation processing. The automatic formation processing and the partial formation processing will be described below.

The distinguishing unit 253 distinguishes whether the player owns each of the plurality of game media included in the party information related to the game medium group of the other player (hereinafter, simply referred to as “party information of the other player”). In one example, it is distinguished whether each game medium ID included in the party information that belongs to the other player and that is selected by the player matches a game medium ID stored in the storage device 14 in association with the player. When the game medium ID included in the party information of the other player matches one of the plurality of game medium IDs stored in the storage device 14 in association with the player, the distinguishing unit 253 can distinguish the game medium of the other player as being owned by the player. When the game medium ID included in the party information of the other player matches none of the plurality of game medium IDs stored in the storage device 14 in association with the player, the distinguishing unit 253 can distinguish the game medium of the other player as not being owned by the player.

The distinguishing unit 253 can output the distinguishing result to the party information association unit 254. When the game medium ID included in the party information of the other player matches one of the plurality of game medium IDs stored in the storage device 14 in association with the player, the distinguishing result can be the game medium ID of the game medium that matches the game medium owned by the player and that is included in the party information of the other player. When the game medium ID included in the party information of the other player matches none of the plurality of game medium IDs stored in the storage device 14 in association with the player, the distinguishing result can be information indicating that the game medium included in the party information of the other player matches none of the owned game media.

When the owned game medium owned by the player is included in the plurality of game media included in the party information of the other player, the party information association unit 254 executes party information association processing of associating the owned game medium with the party information of the player. Specifically, based on the distinguishing result of the distinguishing unit 253, the party information association unit 254 stores the ID of the owned game medium that matches the game medium ID included in the party information of the other player, and the party information of the player in the storage device 14 in association with each other. Note that although the ID of the owned game medium and the game medium ID included in the party information of the other player match each other, preconditions such as a game execution status and a game achievement level are different between the player and the other player. Thus, pieces of information associated with these game medium IDs (for example, game medium level, attack power, HP, ability unlocking status, experience point, and the like) can be different. That is, even when the party information association processing is performed, information of the game medium of the other player does not need to be associated.

When the unowned game medium not owned by the player is included in the plurality of game media included in the party information of the other player, the party information association unit 254 executes substitute determination processing of determining a substitute game medium that substitutes the unowned game medium from the owned game media of the player, and executes party information association processing of associating the determined game medium with the party information of the player. The unowned game medium refers to a game medium not owned by the player among the plurality of game media included in the party information related to the game medium group of the other player. Therefore, the unowned game medium refers to a game medium owned by the other player. On the other hand, the owned game medium refers to a game medium owned by the player.

An example of the association with the party information of the player in the party information association unit 254 is as follows. That is, the party information association unit 254 overwrites or replaces the game medium IDs included in the party information related to the game medium group that belongs to the player and that is selected by the player with the ID of the owned game medium matching the game medium ID included in the party information of the other player and the substitute game medium ID, and associates the owned game medium ID and the substitute game medium ID with the party information ID of the player. Thus, the party information association unit 254 can associate the owned game medium ID and the substitute game medium ID with the party information related to the game medium group selected by the player.

In the substitute determination processing, the party information association unit 254 can determine that an owned game medium that belongs to the player and that is associated with element information that matches or is similar to the element information associated with the game medium included in the party information of the other player is a substitute game medium.

The substitute determination processing is processing of determining a game medium serving as a substitute (substitute game medium) from the game media owned by the player in a case where the player does not own the game medium included in party information of the other player when the party information (game medium group) of the other player is copied to the party information (game medium group) of the player. The substitute determination processing can be referred to as automatic formation processing.

An example of a method of determining a substitute game medium is as follows. That is, the game media included in the party information of the other player and the owned game media of the player each are associated with element information. The party information association unit 254 identifies element information associated with the unowned game medium of the plurality of game media included in the party information of the other player, and identifies game media associated with the identified element information from the plurality of owned game media. In one example, the plurality of owned game media can be all game media owned by the player, and, in another example, can be owned game media having a predetermined parameter (for example, level or the like) equal to or greater than a certain value. The party information association unit 254 determines a substitute game medium from the identified game media. When a plurality of identified game media are present, in one example, the party information association unit 254 can randomly determine a substitute game medium therefrom. In another example, the party information association unit 254 can determine that an owned game medium having the most pieces of matching element information is a substitute game medium.

In addition, the party information association unit 254 can determine a substitute game medium based on the priority of element information, that is, individual element information. For example, when the unowned game medium among the plurality of game media included in the party information of the other player is associated with a plurality of pieces of individual element information associated with different priorities, the party information association unit 254 determines whether an owned game medium is present having matching individual element information until the owned game medium having the matching individual element information is identified in descending order of the priority of the unowned game medium, and determines a substitute game medium from the identified owned game media. In addition, the party information association unit 254 may determine that an owned game medium having the most pieces of matching individual element information in the priority in which the individual element information matches is a substitute game medium. This is because it can be said that an owned game medium having more pieces of matching individual element information has similar features and/or characteristics to the unowned game medium.

In the substitute determination processing, when the owned game media of the player include game media associated with a rarity degree equal to or higher than the rarity degree of the unowned game medium, the party information association unit 254 can determine a substitute game medium from the owned game media that belong to the player and that have a rarity degree equal to or higher than the rarity degree of the unowned game medium. When the owned game media of the player do not include game media associated with a rarity degree equal to or higher than the rarity degree of the unowned game medium, the party information association unit 254 can determine a substitute game medium from game media having the highest rarity degree among game media having individual element information matching the individual element information associated with the unowned game medium among owned game media that belong to the player and that have a rarity degree lower than the rarity degree of the unowned game medium.

For example, when the rarity degree of the unowned game medium is 3 and the player owns owned game media having rarity degrees of 5, 4, 3, 2, and 1, the party information association unit 254 determines a substitute game medium from the owned game media having rarity degrees of 5, 4, and 3. When the rarity degree of the unowned game medium is 5 and the player owns owned game media having rarity degrees of 4, 3, 2, and 1, the party information association unit 254 identifies owned game media associated with individual element information matching the individual element information of the unowned game media among the owned game media having rarity degrees of 4, 3, 2, and 1, and determines that an owned game medium having the highest rarity degree among the identified owned game media is a substitute game medium. In this case, the above-described individual element information can be the type of an ability associated with a priority, and the rarity degree can be individual element information having a higher priority than the individual element information of the ability. In other words, the party information association unit 254 may select owned game media based on individual element information related to a rarity degree having a high priority, further select, from the selected owned game media, owned game media based on individual element information related to an ability having a lower priority than the rarity degree, and select an owned game medium again based on a rarity degree having a high priority to determine a substitute game medium.

In the substitute determination processing, the party information association unit 254 can determine that, among the owned game media of the player, a game medium associated with element information matching the element information for the identified category of the unowned game medium is a substitute game medium. The category of the unowned game medium is a category associated with a game medium not owned by the player among the plurality of game media included in the party information of the other player, and can be identified by the category identification unit 255. The category is, for example, a category corresponding to a first game medium (first player character) or a category corresponding to a second game medium (second player character).

When the unowned game medium is included in the plurality of game media included in the party information of the other player, the party information association unit 254 can execute, in accordance with selection by the player, the substitute determination processing or the partial formation processing of associating only the owned game medium included in the party information of the other player with the party information of the player.

The category identification unit 255 identifies the category of the unowned game medium distinguished by the distinguishing unit 253 as not being owned by the player among the plurality of game media included in the party information of the other player. For example, the category identification unit 255 acquires the party information of the other player and information associated with the party information (for example, including the setting of the association between the game media) from the outside of the information processing apparatus 10 such as a server of the game administrator or the like, identifies the category associated with the unowned game medium, and identifies whether the unowned game medium is the first player character or the second player character.

Next, the screens G1 to G7 will be described in detail.

FIG. 6 illustrates an example of the party formation screen. As illustrated in FIG. 6, the setting unit 251 causes the display device 13 to display the party formation screen G1, and receives selection by the player of a player character, an equipment item, an ability item, and the like via the input device 12. In one example, the party formation screen G1 can be displayed by pressing a party button displayed on a home screen (not illustrated).

In the example illustrated in FIG. 6, the party formation screen G1 includes first player character setting areas R11, second player character setting areas R12, equipment item setting areas R13, ability item setting areas R14, a player character information display area R15, a party name display area R16, a party switching area R17, SET switching tabs R18, and a SET edit button R19.

Each first player character setting area R11 is an area for setting a first player character. When the area R11 is tapped by the player, the party formation screen G1 transitions to a player character group display screen (not illustrated), and selection by the player of a first player character from a plurality of player characters displayed on the player character group display screen is received. When the selection is received and the screen returns to the party formation screen G1, an image of the selected first player character is displayed in the first player character setting area R11. When the setting is not performed, a display indicating that the setting is not performed (for example, a display of a “+” mark) is presented as in the rightmost first player character setting area R11 in FIG. 6.

Note that one of the first player character setting areas R11 may be used as an area for setting a first player character serving as a leader.

Each second player character setting area R12 is an area for setting a second player character. When the area R12 is tapped by the player, the party formation screen G1 transitions to the player character group display screen (not illustrated), and selection by the player of a second player character from a plurality of player characters displayed on the player character group display screen is received. When the selection is received and the screen returns to the party formation screen G1, an image of the selected second player character is displayed in the second player character setting area R12. When the setting is not performed, a display indicating that the setting is not performed (for example, a display of a “+” mark) is presented as in the rightmost second player character setting area R12 in FIG. 6.

Each equipment item setting area R13 is an area for setting an equipment item. When the area R13 is tapped by the player, the party formation screen G1 transitions to an equipment item group display screen (not illustrated), and selection by the player of an equipment item from a plurality of equipment items displayed on the equipment item group display screen is received. When the selection is received and the screen returns to the party formation screen G1, an image of the selected equipment item is displayed in the equipment item setting area R13. When the setting is not performed, a display indicating that the setting is not performed (for example, a display of a “+” mark) is presented in the equipment item setting area R13. In the example illustrated in FIG. 6, the equipment item can be set for each first player character, but may also be set for each second player character.

Each ability item setting area R14 is an area for setting an ability item. When the area R14 is tapped by the player, the party formation screen G1 transitions to an ability item group display screen (not illustrated), and selection by the player of an ability item from a plurality of ability items displayed on the ability item group display screen is received. When the selection is received and the screen returns to the party formation screen G1, an image of the selected ability item is displayed in the ability item setting area R14. In the example illustrated in FIG. 6, the ability item can be set for each first player character, but may also be set for each second player character.

The player character information display area R15 is an area for displaying information about the game media set in the areas R11 to 14. In the example illustrated in FIG. 6, the names of the first player characters, the second player character, and the equipment items, and various parameters of the first player characters or various parameters obtained by taking the parameters of the first and second player characters and the equipment items into consideration are displayed.

The party name display area R16 is an area for displaying the name of a party. In this area R16, it is possible to receive the name of a party from the player and display the received name.

The party switching area R17 is an area for receiving an operation for switching a party to be formed. In the area R17, the number of displayed circle marks is the number of parties that can be formed, and a large circle mark is displayed for a party to be formed. As for switching of a party to be edited, the player swipes the area R17 so that the screen is switched to the party formation screen G1 for a party to be formed. In the example illustrated in FIG. 6, ten circle marks are displayed in the area R17. In other words, ten parties can be set and formed for each SET.

Each SET switching tab R18 is a tab for switching a SET of parties. In each SET, a plurality of parties can be set and formed. In the example illustrated in FIG. 6, six SET switching tabs R18 are displayed. Therefore, in the example illustrated in FIG. 6, a total of 60 parties can be set and formed.

The SET edit button R19 is a button for editing, such as changing the order of parties or deletion of parties in each SET. When the SET edit button R19 is pressed, the screen transitions to a SET edit screen (not illustrated).

FIG. 7 illustrates an example of the game selection screen. The game selection screen G2 is a screen for the player to select a game to be played. The game selection screen G2 illustrated in FIG. 7 includes one or more game display areas R21 and one or more recommended parties buttons R22. Each game display area R21 is an area for displaying the content of a game including the name and level of the game, and the party selection reception unit 252 receives selection of the area R21 and causes the game control unit 25 to execute the game. Each recommended parties button R22 is displayed in association with a corresponding one of the game display areas R21, and is a button for displaying game medium groups of other players who have cleared the game indicated by the game display area R21, for example, like the another player party selection reception screen G3.

FIG. 8 is an example of the another player party selection reception screen. The another player party selection reception screen G3 is a screen for displaying a list of game medium groups of other players. In one example, the another player party selection reception screen G3 displays a list of game medium groups of other players who have cleared a predetermined game. The another player party selection reception screen G3 includes game medium group display areas R31 of the other players, copy buttons R32, and a return button R33. Each game medium group display area R31 is an area for displaying a game medium group of another player, which includes a rank of the other player, a name of a party, and images of a player character, an equipment item, and an ability item. Each copy button R32 is displayed in association with a corresponding one of the game medium group display areas R31, and is a button for copying the game medium group in the area R31. The player selects the copy button R32, so that the party selection reception unit 252 identifies the game medium group that belongs to the other player and that serves as a copy source. The return button R33 is a button for returning to the previous screen such as the game selection screen G2. By selecting the return button R33, the party selection reception unit 252 causes the display device 13 to display the previous screen.

FIG. 9 is an example of the player party selection reception screen. The player party selection reception screen G4 is a screen for displaying a list of game medium groups of the player together with the selected game medium group display area R31 of the other player. The player party selection reception screen G4 illustrated in FIG. 9 includes SET switching tabs R40, the selected game medium group display area R31 of the other player, game medium group display areas R41 of the player, copy buttons R42, and a return button R43. Each SET switching tab R40 is a tab for switching a SET of parties. In the example illustrated in FIG. 9, six SET switching tabs R40 are displayed, and the tab of a SET 1 is selected. Each game medium group display area R41 is an area for displaying a game medium group of the player, which includes a party name and images of a player character, an equipment item, and an ability item. The player selects from the game medium group display areas R41, so that the party selection reception unit 252 identifies a game medium group serving as a copy destination. The game medium group that belongs to the player and that serves as the copy destination is a subject to be overwritten or replaced with the game medium group that belongs to the other player and that serves as the copy source.

Each copy button R42 is displayed in association with a corresponding one of the game medium group display areas R41, and is a button for copying the game medium group in the area R41. The player selects the copy button R42, so that the party selection reception unit 252 identifies the game medium group that belongs to the player and that serves as a copy source. The identified game medium group can be copied to a game medium group in the same SET or a game medium group in another SET by the game control unit 25. That is, the copy button R42 is a button for copying the composition of a certain game medium group of the player to another game medium group of the player. The return button R43 is a button for returning to the previous screen such as the another player party selection reception screen G3. By selecting the return button R43, the party selection reception unit 252 causes the display device 13 to display the previous screen.

FIG. 10 illustrates an example of the confirmation screen. The confirmation screen G5 is a screen for confirming whether to copy the game medium group that belongs to the other player and that is selected by the player to the game medium group that belongs to the player and that is selected by the player. The confirmation screen G5 is displayed on the display device 13 by the party selection reception unit 252 when one of the game medium group display areas R41 is selected by the player on the player party selection reception screen G4.

The confirmation screen G5 illustrated in FIG. 10 includes a copy source and copy destination game medium groups display area R50, a copy button R51, and a cancel button R52. The copy source and copy destination game medium groups display area R50 include the game medium group display areas R31 and R41 selected by the player. The copy button R51 is a button for copying the game medium group that belongs to the other player and that serves as the copy source to the game medium group that belongs to the player and that serves as the copy destination. However, when the player does not own any game medium included in the game medium group that belongs to the other player and that serves as the copy source, and the copy button R51 is selected, the party selection reception unit 252 causes the display device 13 to display the formation processing selection screen G6. The cancel button R52 is a button for returning to the previous screen. By selecting the cancel button R52, the party selection reception unit 252 causes the display device 13 to display the previous screen.

FIG. 11 illustrates an example of the formation processing selection screen. The formation processing selection screen G6 is a screen displayed on the display device 13 by the party selection reception unit 252 when an unowned game medium not owned by the player is present among the plurality of game media included in the party information of the other player. The player selects the copy button R51 on the confirmation screen G5, so that the formation processing selection screen G6 is displayed on the display device 13. The formation processing selection screen G6 illustrated in FIG. 11 includes a notification area R60, an automatic formation button R61, a partial formation button R62, and a cancel button R63.

The notification area R60 is an area for displaying a notification including the presence of the unowned game medium, an image of the unowned game medium, and a text prompting the player to select the automatic formation processing or the partial formation processing. The automatic formation button R61 is a button for performing the substitute determination processing for the unowned game medium. The partial formation button R62 is a button for associating only an owned game medium owned by the player among the plurality of game media included in the party information of the other player with the party information of the player without performing the substitute determination processing for the unowned game medium. The cancel button R63 is a button for returning to the previous screen. By selecting the cancel button R63, the party selection reception unit 252 causes the display device 13 to display the previous screen.

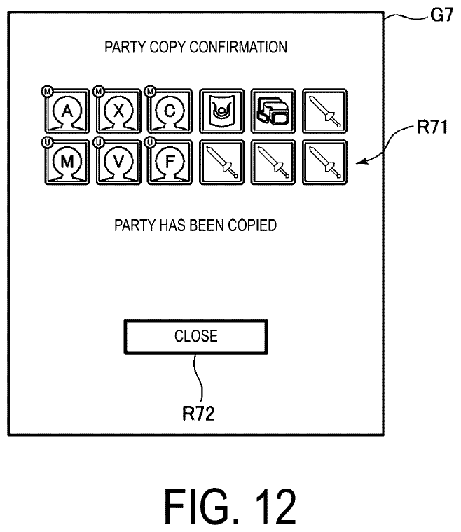

FIG. 12 illustrates an example of a copy notification screen. A copy notification screen G7 is a screen for notifying that the copy of the game medium group of the other player has been completed. When no unowned game medium is present in the selected game medium group of the other player, the screen G7 is displayed on the display device 13 by, for example, the party information association unit 254. The copy notification screen G7 includes a notification information display area R71 and a close button R72. In the notification information display area R71, images of the game media included in the selected game medium group of the other player and a text indicating that the game medium group has been copied are displayed. The close button R72 is a button for closing the copy notification screen G7.

### Operation

### Copy-Related Processing

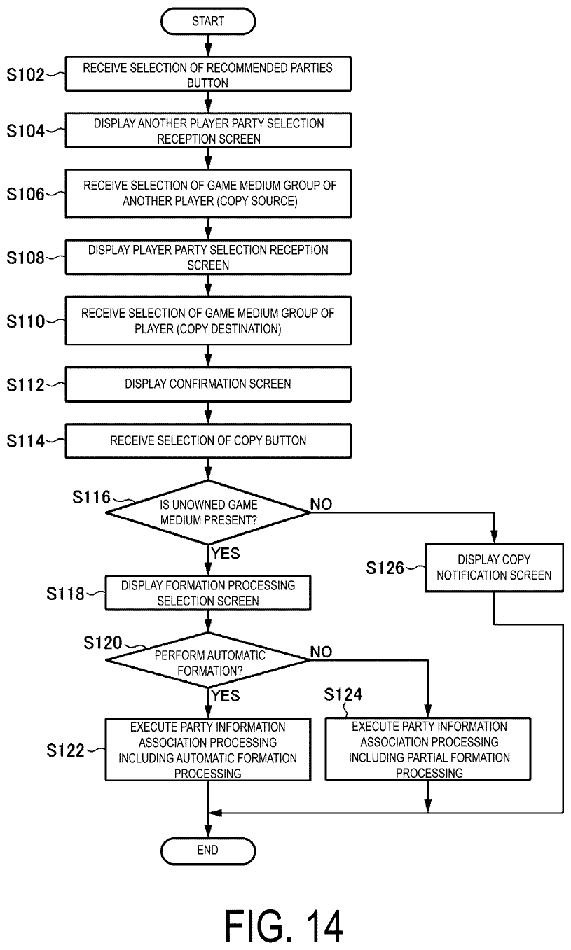

An example of copy-related processing 100 of party information related to a game medium group of another player by the information processing apparatus 10 according to the embodiment of the present invention will be described with reference to FIG. 14. Here, it is assumed that the game selection screen G2 is displayed on the display device 13.

First, in the information processing apparatus 10, the party selection reception unit 252 receives selection by the player from the recommended parties buttons R22 displayed on the game selection screen G2 (S102), and the party selection reception unit 252 causes the display device 13 to display the other player party selection reception screen G3 (S104). The screen G3 can display the plurality of game medium group display areas R31 of other players who have cleared the game corresponding to the selected recommended parties button R22. The party selection reception unit 252 receives selection by the player of a game medium group of another player via the input device 12 (S106). That is, an input operation on the copy button R32 corresponding to the game medium group display area R31 related to the selected game medium group is received. Accordingly, the game medium group that belongs to the other player and that serves as a copy source is identified. Note that information (for example, party information, various images, and the like) related to the game medium groups displayed on the other player party selection reception screen G3 can be acquired by the party selection reception unit 252 from the outside of the information processing apparatus 10 such as the server of the game administrator or the like.

Next, after the selection by the player of the game medium group of the other player is received, the party selection unit 252 causes the display device 13 to display the player party selection reception screen G4 (S108) and receives selection of a game medium group that belongs to the player and that serves as a copy destination (S110). Note that the selection in S110 is an input operation on the game medium group display area R41, and is not an input operation on the copy button R42.

After S110, the party selection reception unit 252 causes the display device 13 to display the confirmation screen G5 (S112), and here, receives selection by the player of the copy button R51 (S114). Thereafter, the distinguishing unit 253 distinguishes whether the player owns each of the plurality of game media included in the game medium group that belongs to the other player and that serves as the copy source. That is, the distinguishing unit 253 distinguishes whether an unowned game medium not owned by the player is present in the game medium group serving as the copy source (S116).

When an unowned game medium is present (YES in S116), the party selection reception unit 252 causes the display device 13 to display the formation processing selection screen G6 (S118), and here, receives selection by the player of either the automatic formation button R61 or the partial formation button R62 (S120).

When the party selection reception unit 252 receives selection of the automatic formation button R61 (YES in S120), the party information association unit 254 receives the distinguishing result of the distinguishing unit 253 and executes the party information association processing including the automatic formation processing (S122). Specifically, for an owned game medium owned by the player among the plurality of game media included in the game medium group serving as the copy source, the party information association unit 254 executes the party information association processing of associating the owned game medium with the party information of the player. Moreover, for an unowned game medium, the party information association unit 254 executes the automatic formation processing, that is, the substitute determination processing and executes the party information association processing of associating a determined substitute game medium with the party information of the player. Here, the association with the party information of the player refers to overwriting or substituting the plurality of game medium IDs included in the party information that belongs to the player and that serves as the copy destination with the game medium ID of the owned game medium included in the party information that belongs to the other player and that serves as the copy source and the game medium ID of the substitute game medium. Therefore, the party information that belongs to the player and that serves as the copy destination after S122 can include the game medium ID of the owned game medium that matches a game medium included in the game medium group that belongs to the other player and that serves as the copy source, and the game medium ID of the substitute game medium.

When the party selection reception unit 252 receives selection of the partial formation button R62 (NO in S120), the party information association unit 254 receives the determination result of the determination unit 253 and executes the party information association processing including the partial formation processing (S124). Specifically, for an owned game medium owned by the player among the plurality of game media included in the game medium group serving as the copy source, the party information association unit 254 executes the party information association processing of associating the owned game medium with the party information of the player. Moreover, for an unowned game medium, the party information association unit 254 deletes the copy destination game medium ID other than the ID of the owned game medium that matches a game medium of the copy source without executing the substitute determination processing. Therefore, the party information that belongs to the player and that serves as the copy destination after S124 includes the game medium ID of the owned game medium that matches a game medium included in the game medium group that belongs to the other player and that serves as the copy source, and does not include the game medium ID of the unowned game medium. When this party information is referred to by the setting unit 251 when editing the game medium group, the areas R11 to 14 corresponding to the game medium IDs of owned game media that match game media included in the game medium group that belongs to the other player and that serves as the copy source displays images corresponding to the IDs, and the areas R11 to 14 corresponding to unowned game media display “+” marks and are left blank. After S122 and S124, the information processing apparatus 10 can cause the display device 13 to display the game selection screen G2.

In this way, the game medium group that belongs to the other player and that serves as the copy source is copied to the game medium group that belongs to the player and that serves as the copy destination. The player can play the game by using the copied game medium group.

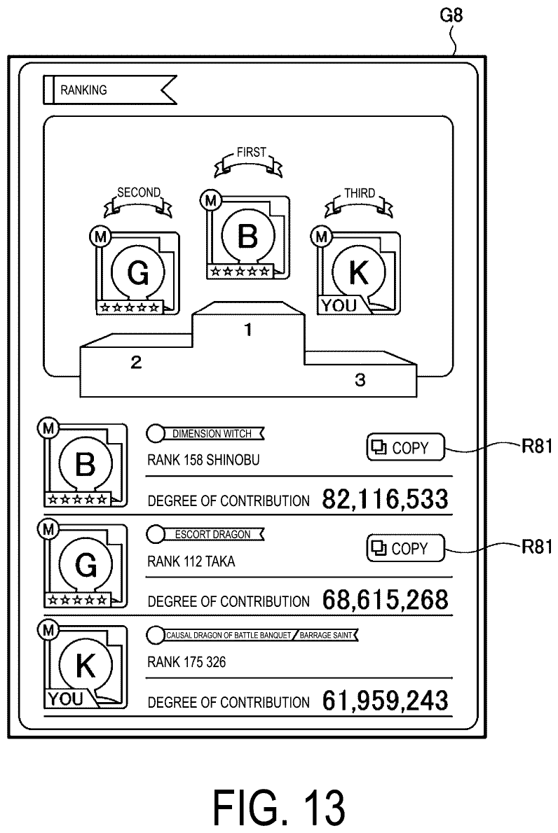

Note that although the above-described copy-related processing 100 starts from the game selection screen G2, the screens before and after the copy-related processing 100 may be any screen. For example, the copy-related processing 100 may start from a multiplayer game result screen G8 as illustrated in FIG. 13.

The multiplayer game result screen G8 is a screen showing a result of executing a multiplayer game, and displays a game result of the player and other players who have played the multiplayer game. The game result includes the degree of contribution acquired by each player and the rank based on the degree of contribution. As illustrated in FIG. 13, with respect to the game result of each of the other players, information related to the game medium group used by the other player in the multiplayer game and a copy button R81 associated with the game medium group are displayed. The information may include an image of a game medium included in the game medium group (here, an image of a player character serving as a leader), an attribute thereof, and a rarity degree thereof. The copy button R81 is a button for copying the game medium group that belongs to the other player and that corresponds to the button R81, and has the same function as that of the copy button R32. Therefore, when the processing starts from the multiplayer game result screen G8, selection of the copy button R81 is received instead of steps S102 to S106, and the information processing apparatus 10 can execute the steps in S108 to S124.

### Game Processing

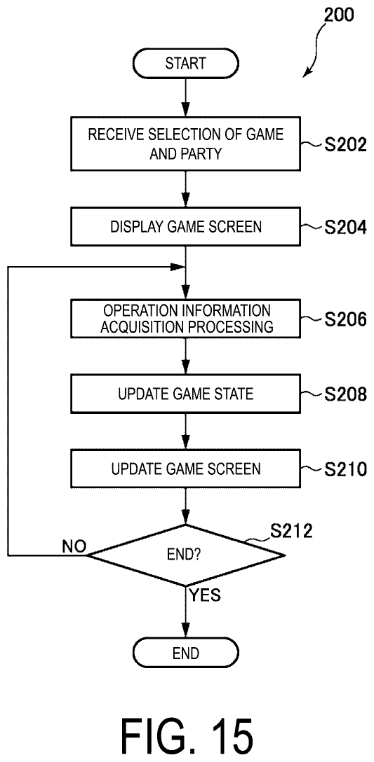

Game processing 200 executed in the information processing apparatus 10 according to the embodiment of the present invention will be described with reference to FIG. 15. Note that a smartphone is used as the information processing apparatus 10 in the present embodiment, and the frame rate of a smartphone is typically set to 30 fps, 60 fps, or the like. The information processing apparatus 10 preferably executes the processing at regular time intervals in accordance with the frame rate. Here, description will be given on the assumption that a party to be used in a game has already been formed, being set through the copy-related processing 100 or by the setting unit 251. First, the information processing apparatus 10 receives selection by the player of a game and a party to be used in the game (S202).

When the game starts, the information processing apparatus 10 displays a game screen including a game field 50 as illustrated in FIG. 3 (S204). Next, the information processing apparatus 10 executes operation information acquisition processing of acquiring information about a touch input by the player on the touch panel 12a functioning as the input part 21 (S206). The game control unit 25 continuously executes the skill processing in parallel with the game processing 200 until the game ends. The skill processing is executed based on the operation information acquired in the game processing 200.

Next, the information processing apparatus 10 updates a game state (S208). The game state includes information about dynamic parameters and individual parameters of various objects, collision determination, and the game field 50. For example, the information processing apparatus 10 updates the dynamic parameters of the various objects based on dynamic parameters in the immediately preceding frame, an elapsed time from the immediately preceding frame, the virtual gravity, a collision determination result in the immediately preceding frame, and the like, thereby updating the locations and the speeds of the various objects. For example, the elapsed time is calculated from the frame rate and the number of elapsed frames.

The information processing apparatus 10 performs collision determination based on the updated dynamic parameters of the various objects. Furthermore, the information processing apparatus 10 updates the individual parameters of the various objects based on a collision determination result in the frame, an activated skill, individual parameters in the immediately preceding frame, and the like. It is understood by those skilled in the art that whether the leading object 52 and the enemy object 54a or the attack object 54b collide with each other can be determined by various methods using the dynamic parameters of the leading object 52 and the enemy object 54a or the attack object 54b.

Next, the information processing apparatus 10 updates the game screen by rendering the game screen based on the updated game state (S210). For example, the information processing apparatus 10 determines the locations and states of the various objects from the updated dynamic parameters and individual parameters of the various objects and renders the game screen, thereby displaying the updated game screen on the display device 13. For example, when the updated HP of the individual parameters of the enemy object 54a is zero, the enemy object 54a disappears from the game field 50 included in the updated game screen.

Unless the game ends in S210, this processing returns to S206. This processing can be executed in parallel with other processing such as the collision determination processing and the skill processing in synchronization as necessary.

Note that the processing of each step in each flowchart described above is merely an example. As long as the same result can be obtained, the processing order of the steps may be changed, or other processing may be executed in addition to or instead of the processing of each step. For example, the processing of the set of S104 and S106 and the processing of the set of S108 and S110 can be interchanged. The order of the processing from S202 to S210 can be changed.

### Actions and Effects

(1) The information processing apparatus 10 according to the present embodiment is an information processing apparatus for executing a game including an operation of forming, by a player, a game medium group including a plurality of game media, the information processing apparatus including: the distinguishing unit 253 configured to distinguish whether the player owns each of a plurality of game media included in party information related to a game medium group of another player; and the party information association unit 254 configured to execute: when an owned game medium owned by the player is included in the plurality of game media included in the party information of the other player, party information association processing of associating the owned game medium with party information of the player; and when an unowned game medium not owned by the player is included in the plurality of game media included in the party information of the other player, substitute determination processing of determining, from a plurality of the owned game media of the player, a substitute game medium substituting the unowned game medium, and party information association processing of associating the determined game medium with the party information of the player.

Accordingly, since the substitute game medium is determined when the player does not own the game medium included in the party information of the other player, it is possible to improve player-friendliness in the game medium group formation.
(2) In the substitute determination processing, the party information association unit 254 determines, as the substitute game medium, the owned game medium that belongs to the player and that is associated with element information matching element information associated with a game medium included in the party information of the other player.

Accordingly, when the player does not own the game medium included in the party information of the other player, a game medium similar to the game medium is determined to be the substitute game medium, and thus it is possible to further improve player-friendliness in the game medium group formation.
(3) When the unowned game medium is included in the plurality of game media included in the party information of the other player, the party information association unit 254 executes, in accordance with selection by the player, the substitute determination processing or partial formation processing of associating only the owned game medium included in the party information of the other player with the party information of the player.

Accordingly, regardless of whether the player selects the substitute determination processing or the partial formation processing, at least the owned game medium is associated with the party information of the player. Therefore, when the player forms a group by imitating the formation of the other player, there is no need to reconfigure the formation of the other player from scratch. As a result, it is possible to improve player-friendliness in the game medium group formation.
(4) In the substitute determination processing: when a game medium associated with a rarity degree equal to or higher than a rarity degree of the unowned game medium is included in the plurality of owned game media of the player, the party information association unit 254 determines the substitute game medium from the plurality of owned game media that belong to the player and that have a rarity degree equal to or higher than the rarity degree of the unowned game medium; and when the game medium associated with the rarity degree equal to or higher than the rarity degree of the unowned game medium is not included in the plurality of owned game media of the player, the party information association unit determines the substitute game medium from game media having a highest rarity degree among game media having individual element information matching individual element information associated with the unowned game medium among the plurality of owned game media that belong to the player and that have a rarity degree lower than the rarity degree of the unowned game medium.

Accordingly, even when the unowned game medium is included in the party information of the other player, it is possible to determine a substitute game medium similar to the unowned game medium, and it is possible to improve player-friendliness in the game medium group formation.
(5) At least one type of game medium is associated with a category corresponding to a first game medium and a category corresponding to a second game medium assisting the first game medium, the at least one type of game medium in each category being associated with different element information, each of the plurality of game media included in the party information of the other player is associated with the category corresponding to the first game medium or the second game medium, the information processing apparatus 10 further includes the category identification unit 255 configured to identify the category of the unowned game medium distinguished as not being owned by the player. In the substitute determination processing, the party information association unit 254 determines, as the substitute game medium, a game medium among the plurality of owned game media of the player associated with the element information matching the element information for the identified category of the unowned game medium.

Accordingly, since the substitute game medium can be determined in accordance with the category corresponding to the game medium, it is possible to improve player-friendliness in the formation of the game medium group.
(6) The party information of the other player is party information related to a game medium group with which the other player has cleared a predetermined game. Accordingly, the game medium group formation advantageous for the predetermined game can be used as game medium group formation of the player, and thus it is possible to improve player-friendliness in the formation.
(7) The predetermined game includes a multiplayer game. Accordingly, it is possible to at least partially obtain the composition of the game medium group that belongs to the other player and that is used in the multiplayer game cleared together with the player, and thus it is possible to improve player-friendliness in the formation of the game medium group.

### Embodiment Achieved by System

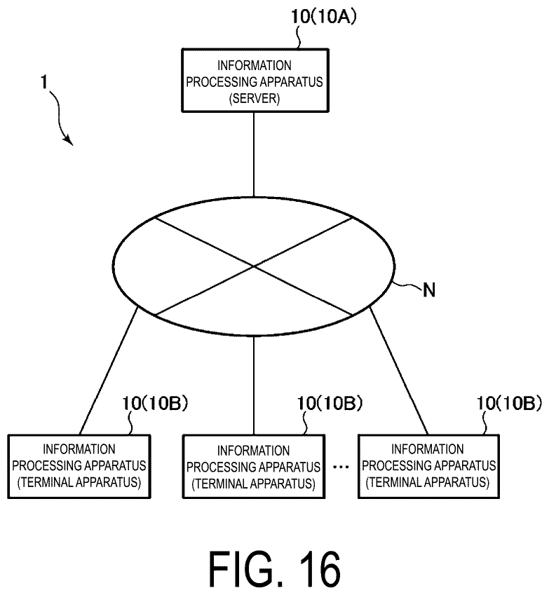

FIG. 16 is a diagram illustrating an example of an overall configuration of the game system according to the embodiment of the present invention. As illustrated in FIG. 16, a game system 1 includes a plurality of the information processing apparatuses 10. At least one of the plurality of information processing apparatuses 10 is a server 10A, and the other information processing apparatuses 10 are terminal apparatuses 10B that are user terminals used by respective players. The server 10A and each terminal apparatus 10B are connected to a network N such as the Internet in a mutually communicable manner. Note that the game system 1 of the present embodiment will be described on the assumption that it is a server-client system, but can be configured as a system without the server 10A, such as PtoP.

The server 10A and the terminal apparatus 10B have a hardware configuration similar to the one illustrated in FIG. 1. The server 10A is a server apparatus that provides a game executable in the terminal apparatus 10B, and includes one or more computers. The terminal apparatus 10B is also a smartphone in the present embodiment.

The server 10A stores various programs such as a control program for controlling a progress of an online game and various types of data used in the game.

In one example, the server 10A is configured to provide the terminal apparatus 10B with a game application executable in the terminal apparatus 10B. When executing the downloaded game application, the terminal apparatus 10B transmits and receives data to and from the server 10A periodically or as necessary and proceeds the game. For example, the server 10A stores various types of setting information, history information, and the like necessary for the game executed in the terminal apparatus 10B. In this case, the terminal apparatus 10B has functions of the input part 21, the output part 22, the storage unit 23, the communication unit 24, the game control unit 25, and the functional units in the game control unit 25.

In one example, the server 10A is a web server and provides a game service to the terminal apparatus 10B. The terminal apparatus 10B acquires HTML data for displaying a web page from the server 10A, analyzes the acquired HTML data, and displays the web page. In this case, the server 10A that communicates with the terminal apparatus 10B has some of the functions of the game control unit 25. For example, the terminal apparatus 10B receives selection of game medium groups of the player and another player via the input part 21 (input device 12), and executes the party information association processing by the distinguishing unit 253 and the party information association unit 254 of the server 10A.

In one example, the game system 1 provides a game that can be played by a plurality of players in one game field 50. For example, the collision objects 54 can be objects operated by other players. The party object 51 can include player objects corresponding to a plurality of players.

### Other Embodiments

In another embodiment of the present invention, a program for implementing the functions of the above-described embodiment of the present invention and the information processing illustrated in the flowchart, and a computer-readable storage medium storing the program can be provided. In still another embodiment, a method for implementing the functions of the above-described embodiment of the present invention and the information processing illustrated in the flowchart can be provided. In still another embodiment, a server that can supply a computer with a program for implementing the functions of the above-described embodiment of the present invention and the information processing illustrated in the flowchart can be provided. In still another embodiment, a virtual machine for implementing the functions of the above-described embodiment of the present invention and the information processing illustrated in the flowchart can be provided.

The processing or operation described above can be freely changed as long as a contradiction in the processing or operation does not occur, for example, use of data in a certain step that should be not usable in the step. Each of the examples described above is an example for describing the present invention, and the present invention is not limited to these examples. The present invention can be carried out in various forms without departing from the gist thereof.

For example, in the above embodiment, the game is a pinball game, but the game is not limited thereto. The game is only required to be a game in which a party is formed and which proceeds using the formed party, and such a game is included in the scope of the present invention. For example, the scope of the present invention includes a card game played with game media indicating a plurality of (for example, several tens of) cards formed in a deck.

### Reference Signs List

1 Game system
10 Information processing apparatus
10A Server
10B Terminal apparatus
11 Processor
12 Input device
12a Touch panel
13 Display device
14 Storage device
15 Communication device
16 Bus
21 Input part
22 Output part
23 Storage unit
24 Storage device
25 Game control unit
251 Setting unit
252 Party selection reception unit
253 Distinguishing unit
254 Party information association unit
255 Category identification unit
50 Game field
51 Party object
52 Leading object
53 Following object
54 Collision object
54a Enemy object
54b Attack object
54c Wall
55 Operation object
55a One end portion
55b Another end portion
G1 Party formation screen
G2 Game selection screen
G3 Another player party selection reception screen
G4 Player party selection reception screen
G5 Confirmation screen
G6 Formation processing selection screen
G7 Copy notification screen
G8 Multiplayer game result screen
R11 First player character setting area
R12 Second player character setting area
R13 Equipment item setting area
R14 Ability item setting area
R15 Player character information display area
R16 Party name display area
R17 Party switching area
R18 SET switching tab
R19 SET edit button
R21 Game display area
R22 Recommended parties button
R31 Another player game medium group display area
R32 Copy button
R33 Return button
R41 Player game medium group display area
R42 Copy button
R43 Return button
R50 Copy source and copy destination game medium groups display area
R51 Copy button
R52 Cancel button
R60 Notification area
R61 Automatic formation button
62 Partial formation button
R63 Cancel button
R71 Notification information display area
R72 Close button
R81 Copy button
N Network

1. A non-transitory computer readable medium storing a program for a game including an operation of forming, by a player, a game medium group including a plurality of game media, the program causing an information processing apparatus to function as:
a distinguishing unit configured to distinguish whether the player owns each of a plurality of game media included in party information related to a game medium group of another player; and
a party information association unit configured to execute:
when an owned game medium owned by the player is included in the plurality of game media included in the party information of the other player, party information association processing of associating the owned game medium with party information of the player; and
when an unowned game medium not owned by the player is included in the plurality of game media included in the party information of the other player, substitute determination processing of determining, from a plurality of the owned game media of the player, a substitute game medium substituting the unowned game medium, and party information association processing of associating the determined game medium with the party information of the player.

2. The non-transitory computer readable medium according to claim 1, wherein
in the substitute determination processing, the party information association unit determines, as the substitute game medium, the owned game medium that belongs to the player and that is associated with element information matching element information associated with a game medium included in the party information of the other player.

3. The non-transitory computer readable medium according to claim 1, wherein
when the unowned game medium is included in the plurality of game media included in the party information of the other player, the party information association unit executes, in accordance with selection by the player, the substitute determination processing or partial formation processing of associating only the owned game medium included in the party information of the other player with the party information of the player.

4. The non-transitory computer readable medium according to claim 1, wherein
in the substitute determination processing:
when a game medium associated with a rarity degree equal to or higher than a rarity degree of the unowned game medium is included in the plurality of owned game media of the player, the party information association unit determines the substitute game medium from the plurality of owned game media that belong to the player and that have a rarity degree equal to or higher than the rarity degree of the unowned game medium; and
when the game medium associated with the rarity degree equal to or higher than the rarity degree of the unowned game medium is not included in the plurality of owned game media of the player, the party information association unit determines the substitute game medium from game media having a highest rarity degree among game media having individual element information matching individual element information associated with the unowned game medium among the plurality of owned game media that belong to the player and that have a rarity degree lower than the rarity degree of the unowned game medium.

5. The non-transitory computer readable medium according to claim 1, wherein
at least one type of game medium is associated with a category corresponding to a first game medium and a category corresponding to a second game medium assisting the first game medium, the at least one type of game medium being associated with different element information for each category,
each of the plurality of game media included in the party information of the other player is associated with the category corresponding to the first game medium or the second game medium,
the information processing apparatus is further caused to function as a category identification unit configured to identify the category corresponding to the unowned game medium distinguished as not being owned by the player, and
in the substitute determination processing, the party information association unit determines, as the substitute game medium, a game medium among the plurality of owned game media of the player associated with the element information matching the element information for the identified category of the unowned game medium.

6. The non-transitory computer readable medium according to claim 1, wherein
the party information of the other player is party information related to a game medium group with which the other player has cleared a predetermined game.

7. The non-transitory computer readable medium according to claim 6, wherein
the predetermined game includes a multiplayer game.

8. The non-transitory computer readable medium according to claim 1, comprising at least one or more of the following configurations (2) to (7):
(2) in the substitute determination processing, the party information association unit determines, as the substitute game medium, the owned game medium that belongs to the player and that is associated with element information matching element information associated with a game medium included in the party information of the other player;
(3) when the unowned game medium is included in the plurality of game media included in the party information of the other player, the party information association unit executes, in accordance with selection by the player, the substitute determination processing or partial formation processing of associating only the owned game medium included in the party information of the other player with the party information of the player;
(4) in the substitute determination processing:
when a game medium associated with a rarity degree equal to or higher than a rarity degree of the unowned game medium is included in the plurality of owned game media of the player, the party information association unit determines the substitute game medium from the plurality of owned game media that belong to the player and that have a rarity degree equal to or higher than the rarity degree of the unowned game medium; and
when the game medium associated with the rarity degree equal to or higher than the rarity degree of the unowned game medium is not included in the plurality of owned game media of the player, the party information association unit determines the substitute game medium from game media having a highest rarity degree among game media having individual element information matching individual element information associated with the unowned game medium among the plurality of owned game media that belong to the player and that have a rarity degree lower than the rarity degree of the unowned game medium;
(5) at least one type of game medium is associated with a category corresponding to a first game medium and a category corresponding to a second game medium assisting the first game medium, the at least one type of game medium being associated with different element information for each category,
each of the plurality of game media included in the party information of the other player is associated with the category corresponding to the first game medium or the second game medium,
the information processing apparatus is further caused to function as a category identification unit configured to identify the category of the unowned game medium distinguished as not being owned by the player, and
in the substitute determination processing, the party information association unit determines, as the substitute game medium, a game medium among the plurality of owned game media of the player associated with the element information matching the element information for the identified category of the unowned game medium;
(6) the party information of the other player is party information related to a game medium group with which the other player has cleared a predetermined game; and
(7) in the configuration (6),
the predetermined game includes a multiplayer game.

9. An information processing apparatus for executing a game including an operation of forming, by a player, a game medium group including a plurality of game media, the information processing apparatus comprising:
a distinguishing unit configured to distinguish whether the player owns each of a plurality of game media included in party information related to a game medium group of another player; and
a party information association unit configured to execute:
when an owned game medium owned by the player is included in the plurality of game media included in the party information of the other player, party information association processing of associating the owned game medium with party information of the player; and
when an unowned game medium not owned by the player is included in the plurality of game media included in the party information of the other player, substitute determination processing of determining, from a plurality of the owned game media of the player, a substitute game medium substituting the unowned game medium, and party information association processing of associating the determined game medium with the party information of the player.

10. A method for a game executed by an information processing apparatus, the game including an operation of forming, by a player, a game medium group including a plurality of game media, the method comprising:
a distinguishing step of distinguishing whether the player owns each of a plurality of game media included in party information related to a game medium group of another player; and
a party information association step of executing:
when an owned game medium owned by the player is included in the plurality of game media included in the party information of the other player, party information association processing of associating the owned game medium with party information of the player; and
when an unowned game medium not owned by the player is included in the plurality of game media included in the party information of the other player, substitute determination processing of determining, from a plurality of the owned game media of the player, a substitute game medium substituting the unowned game medium, and party information association processing of associating the determined game medium with the party information of the player.

11. A system for a game including an operation of forming, by a player, a game medium group including a plurality of game media, the system comprising:
a plurality of information processing apparatuses, wherein
any of the plurality of information processing apparatuses functions as a distinguishing unit configured to distinguish whether the player owns each of a plurality of game media included in party information related to a game medium group of another player, and
any of the plurality of information processing apparatuses functions as a party information association unit configured to execute:
when an owned game medium owned by the player is included in the plurality of game media included in the party information of the other player, party information association processing of associating the owned game medium with party information of the player; and
when an unowned game medium not owned by the player is included in the plurality of game media included in the party information of the other player, substitute determination processing of determining, from a plurality of the owned game media of the player, a substitute game medium substituting the unowned game medium, and party information association processing of associating the determined game medium with the party information of the player.
